(19) United States
(12) Patent Application Publication
(10) Pub. No.: US 2008/0133799 A1
(43) Pub. Date: Jun. 5, 2008

(54) Control and slow data transmission method for serial interface

(75) Inventor: Martti Voutilainen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/998,173

(22) Filed: Nov. 28, 2007

Related U.S. Application Data
(60) Provisional application No. 60/867,506, filed on Nov. 28, 2006.

(51) Int. Cl. G06F 3/00

(52) U.S. Cl. 710/60

(57) ABSTRACT

A scalable low voltage signaling (SLVS) serial interface structure is configured as a 0.4V NMOS totem-pole driver structure for both high speed differential signaling and slow speed single-ended signaling using the same 0.4V NMOS totem-pole driver structure. An un-terminated receiver (Rx) and a CMOS inverter comparator powered from a 0.4 volt supply, is used for receiving the slow speed single-ended 0-100 mega bits per second (Mbps) signaling in a data link. A terminated receiver (Rx) and a differential comparator powered from a 0.4 volt supply, is used for receiving the high speed differential 2 giga bits per second (Gbps) signaling in the data link.

### CROSS REFERENCE TO RELATED APPLICATION

Reference is made to and priority claimed from U.S. patent application Ser. No. 60/867,506, filed Nov. 28, 2006.

### FIELD OF THE INVENTION

The present invention relates generally to serial interfaces and deals more specifically with serial interfaces for communication interconnection between components in a mobile device.

### LIST OF ABBREVIATIONS

DDR Double Data Rate
EMI Electro Magnetic Interference
MIPI Mobile Industry Processor Interface
PHY Physical Layer
SLVS Scalable Low Voltage Signaling
SATA Serial Alliance for Technology Access
Rx Receiver
Tx Transmitter

### BACKGROUND OF THE INVENTION

The Mobile Industry Processor Interface (MIPI) Alliance standard for D-PHY as set forth in draft version 0.81.01 Release 02, incorporated herein by reference, proposes a flexible, low-cost, high-speed serial interface solution for communication interconnection between components inside a mobile device. These interfaces are generally CMOS parallel busses at low bit rates, with slow edges for electromagnetic interference (EMI) reasons. The proposed D-PHY solution attempts to enable significant extension of the interface bandwidth for more advanced applications. D-PHY describes a source synchronous high speed low power PHY. PHY is defined as a functional block that implements the features necessary to communicate over the Lane interconnect which is defined as a two-line, point-to-point interconnect used for both differential high speed signaling and for low power single-ended signaling. D-PHY's communicate on the order of 500 mega bits per second hence the Roman numeral for 500 or “D”. The D-PHY specification was written and generally intended to cover the connection of camera and display applications to a host processor.

D-PHY specifies 1.2 volt CMOS-type signaling be used for control and optionally for slow-speed data transmission. In one example of a D-PHY serial interface, a source-synchronous interface that uses a double data rate (DDR) clock, the differential scalable low voltage signaling (SLVS) signaling is in parallel with 1.2 volt CMOS logic using the same IC pin configuration. The CMOS logic uses the same signal wires for control and short messages, for example, triggers for different operations, such as for example reset, and also for slow speed, up to 10 mega bits per second (Mbps) data transmission.

For a signal to be considered valid at the receiver (Rx) when the first edge of the signal reaches the Rx input, the signal current must be sufficiently large which makes the power consumption of 1.2 volt signaling high per transmitted bit. For signal integrity reasons and to prevent overshoots, the output impedance of the transmitter (Tx) needs to have a value and be at least as large as the line impedance. Nominally, in 50-ohm systems the output current is characterized by the expression: 1.2 volts/(50+50) ohms=12 milli-amperes (mA).

Because of EMI considerations, the transmitter output current needs to be limited to much smaller values than 12 mA. As a result, the signal rise time at the receiver (Rx) input will be slowed down because several back and forth traveling edges are necessary to get the signal amplitude large enough for detection as a valid signal. The time required for the back and forth traveling edges makes it impossible to have high data transmission bit rates with long cables. In other words, to load the line capacitance up to 1.2 volts with <6 mA takes a longer time as compared to loading the line to 0.4 volts, when the maximum current is only 4 mA. An obvious problem resulting from a slow rise time signal at the receiver (Rx) input is that the control messages are slow, for example when changing the D-PHY serial interface from a LP (low power) mode to a HS (high-speed) mode.

There are a number of problems and disadvantages associated with using the MIPI D-PHY 1.2V CMOS signaling interface and include at least the following:

The CMOS driver and CMOS receiver increase the capacitive load at the input and output structures and thus limit cable length.

A further disadvantage is the requirement for the provision of an additional 1.2 volt power supply for the required 1.2 volt supply for this low-power slow CMOS signaling if the 1.2 volt supply is not already present for some other purpose.

In order to reduce power consumption, accommodate longer cable lengths, and make higher bit rate and faster control function possible, the 1.2V CMOS signaling should be replaced by some other method.

What is needed therefore is a way to eliminate the problems and disadvantages of D-PHY 1.2V CMOS logic serial interfaces though use of a single high-speed low voltage MIPI serial interface driver structure for both high-speed differential signaling and for slow speed signaling

### SUMMARY OF THE INVENTION

In accordance with a major aspect of the invention, a scalable low voltage signaling (SLVS) serial interface structure is configured for both high speed differential signaling and slow speed single-ended signaling using the same 0.4V NMOS totem-pole driver structure. An un-terminated receiver (Rx) and a CMOS inverter comparator powered from a 0.4 volt supply, is used for receiving the slow speed single-ended 0-100 mega bits per second (Mbps) signaling in a data link. A terminated receiver (Rx) and a differential comparator powered from a 0.4 volt supply, is used for receiving the high speed differential 2 giga bits per second (Gbps) signaling in the data link.

The single serial interface driver structure of the invention provides a power efficient serial interface with a 90% power reduction, increased speed, increased cable length, and a simplified structure in comparison to D-PHY 1.2 volt CMOS logic serial interface structures.

The single high-speed low voltage serial interface driver structure of the invention is particularly well suited for use in mobile terminals for applications in which high bandwidth serial interfaces are needed.

### BRIEF DESCRIPTION OF THE DRAWINGS

FIG. 1 is a schematic representation of a driver structure implementation of the present invention for a 0.4 volt CMOS transmitter (Tx) and receiver (Rx).

FIG. 2 is a schematic circuit representation of a scalable low voltage signaling (SLVS) driver according to some embodiments of the present invention implemented in a differential NMOS totem-pole driver configuration.

FIG. 3 is a schematic circuit representation of a 0.4 volt CMOS inverter chain according to some embodiments of the invention for implementing the 0.4 volt CMOS inverter of the receiver (Rx).

FIG. 4 is a functional block diagram of an example of a signal processor for carrying out some embodiments of the invention.

FIG. 5 is a functional block representation of a chipset according to some embodiments of the invention.

FIG. 6 shows a waveform representation of a differential signal as seen at the input of the receiver (Rx) when measured by single ended probes when the scalable low voltage signaling (SLVS) driver of FIG. 2 is used with a termination resistor at the receiver (Rx) input for high speed signaling.

FIG. 7 shows a waveform representation of a differential signal as seen at the input of the receiver (Rx) when measured by a differential probe when the scalable low voltage signaling (SLVS) driver of FIG. 2 is used with a termination resistor at the receiver (Rx) input for high speed signaling.

FIG. 8 shows a waveform representation of a single-ended signal as seen at the input of the receiver (Rx) when the scalable low voltage signaling (SLVS) driver shown in FIG. 2 is used without a termination resistor at the receiver (Rx) input for slow-speed signaling.

FIGS. 9a and 9b show a waveform representation of the current and voltage signals respectively for a matched output impedance of 50 ohms according to some embodiments of the invention.

FIGS. 10a and 10b show a waveform representation comparison of a 100 pico-second rise time and 10 nano-second rise time according to some embodiments of the invention.

FIG. 11 shows a waveform representation of filtering at the receiver (Rx) of 200 millivolt peak-to-peak 1 gigahertz noise in 400 millivolt 10 megabits per second single-ended signaling.

FIG. 12 shows a waveform representation of filtering at the receiver (Rx) 1 gigahertz 200 millivolt peak-to-peak noise in 400 millivolt 100 megabits per second single-ended signaling.

### WRITTEN DESCRIPTION OF EXEMPLARY EMBODIMENTS OF THE INVENTION

The MIPI (Mobile Industry Processor Interface) Alliance is presently in the process of standardizing a new serial interface known as M-PHY. In order to make the new interface simple, a single signaling method in accordance with some embodiments of the invention is proposed in which differential signaling using scalable low voltage signaling (SLVS) logic drivers are used for high speed signaling, and the same drivers are used for slow speed single-ended signaling and for receiver wake up purposes rather than the 1.2 volt CMOS signaling specified in the D-PHY specification identified herein above.

Removing the 1.2 volt signaling possibility from M-PHY gives rise to certain problems such as for example, how to wake up a sleeping receiver through the serial link. The 1.2 volt signaling also provides in certain instances, better energy efficiency than starting the phase locked loop's (PLL)'s of transmitter (Tx) and receiver (Rx) modules for example, with frequently sent short control messages.

In general, M-PHY serial interfaces that use 8B10B line coding and embedded clocking, as well as clock and data recovery at the receiver (Rx) and phase lock loop's (PLL)'s at the transmitter (Tx) and receiver (Rx), run continuously all the time. Other similar type interfaces such as those defined by the Serial Alliance for Technology Access (SATA) do not run all the time and use a large amplitude signal to wake-up the receiver (Rx). A similar method to wake up the receiver (Rx) is also proposed for M-PHY serial interfaces when there is no need to send information during long time periods.

In accordance with some embodiments, the method of the invention uses a single high-speed low voltage serial interface driver structure for providing both high speed differential signaling and slow speed single-ended signaling by connecting a resistor termination at the input of a receiver (Rx) for receiving a high speed differential data signal generated by a suitably arranged and configured scalable low voltage signaling (SLVS) driver structure, and by disconnecting the resistor termination from the input of the receiver (Rx) for receiving a slow speed single-ended data signal generated by the SLVS driver structure.

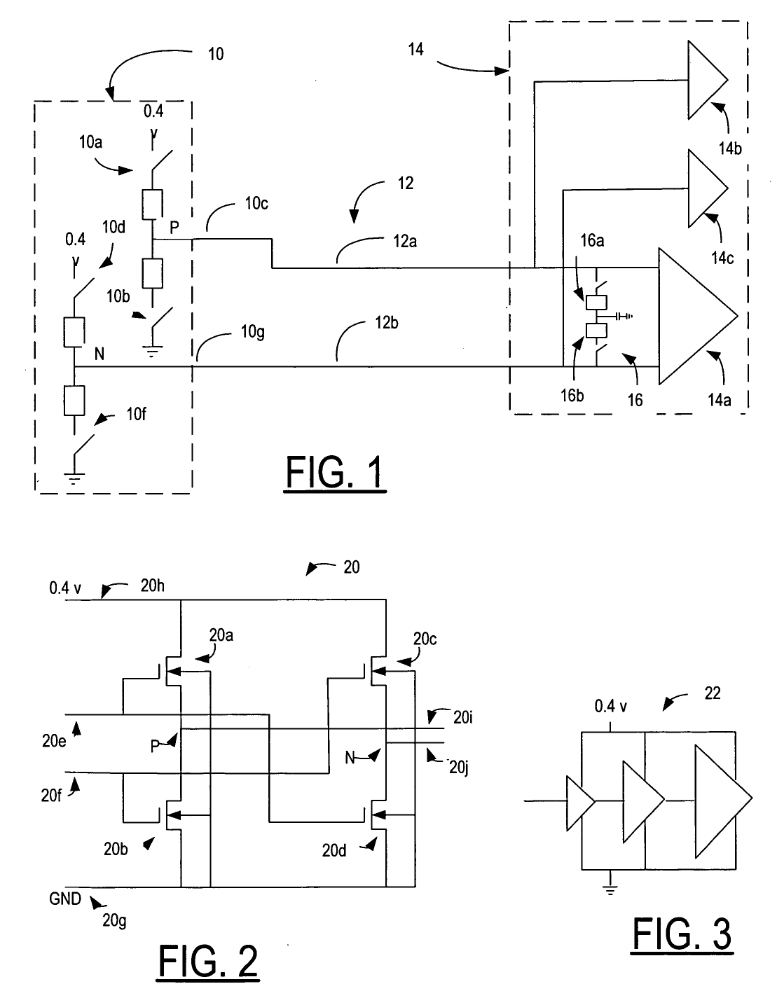

FIG. 1 shows a schematic circuit representation of a driver structure implementation according to some embodiments of the present invention for a 0.4 volt CMOS transmitter (Tx) and receiver (Rx). As shown in FIG. 1, a serial interface driver structure (Tx) generally designated 10 is arranged with high-speed SLVS drivers represented by the switches 10a and 10b for generating the P output 10c, and switches 10d and 10e for generating the N output 10f. The P and N outputs 10c and 10f are connected to the data lane 12 respective signal lines 12a, 12b which lines are used for both the high speed differential signaling and the slow speed single-ended signaling.

A serial interface receiver structure (Rx) generally designated 14 is arranged with a selectively connectable resistor termination generally designated 16 at the input of the receiver structure. The selectively connectable resistor termination 16 as shown includes resistors 16a and 16b, generally 50 ohm resistors. The termination resistors 16a and 16b are connected across the input of a high speed, differential comparator 14a located in the receiver (Rx) 14 for high speed differential signaling.

The receiver (Rx) 14 also includes inverters 14b and 14c arranged for respective connection to the signal lines 12a, 12c for slow speed single-ended signaling. The termination resistors 16a and 16b are deselected or disconnected to remove the termination for slow speed single-ended signaling during a slow speed signaling period.

It should be noted that slew rate control must be properly considered for high-speed and slow speed signaling.

According to some embodiments of the present invention, the scalable low voltage signaling (SLVS) serial interface driver structure may be implemented and configured as a 0.4 volt differential NMOS totem-pole driver such as illustrated by way of example in FIG. 2 and is generally designated 20. The NMOS switches 20a and 20b are connected in series between ground 20g and the 0.4 volt bus 20h. The NMOS switches 20c and 20d are connected in series between ground 20g and the 0.4 volt bus 20h and are in parallel with the series connected NMOS switches 20a and 20b. The gates of NMOS switch 20a and 20d are connected to the input 20e and control the turn-on, turn-off of the switch via a control signal at the input 20e. The gates of NMOS switch 20b and 20c are connected to the input 20f and control turn-on, turn-off of the switch via a control signal at the input 20f. The P output 20i is provided at the junction of the series connection between NMOS switches 20a and 20b. The N output 20j is provided at the junction of the series connection between NMO switches 20c and 20d. The P and N outputs are arranged for connection to the signal lines of the data lane. The functional operation of the 0.4 volt differential NMOS totem-pole driver of FIG. 2 is understood by those skilled in the art and therefore a detailed explanation is not provided herein. The reader is referred to textbooks and literature in the art for a further explanation if such a detailed explanation is desired. It is pointed out that any implementation that makes a 50 ohms switch to 0.4 volts and 50 ohms switch to ground may be used with some embodiments of the invention.

The same scalable low voltage signaling (SLVS) 0.4 volt NMOS switches 20a, 20b, 20c and 20d that are used for 0-2 giga-bits per second (Gbps) high speed differential +/−200 millivolt signaling, are also used for 0-100 mega-bits per second (Mbps) single-ended 400 mV signaling. The 0.4 volt NMOS switches 20a, 20b, 20c and 20d provide clocking signals to the receiver (Rx) via the two single-ended wires 12a and 12b. The 400 mV single-ended signal is of a value sufficiently large enough to be detected by the 0.4 volt CMOS inverter 14a and 14b which are arranged as comparators at the receiver (Rx) 14.

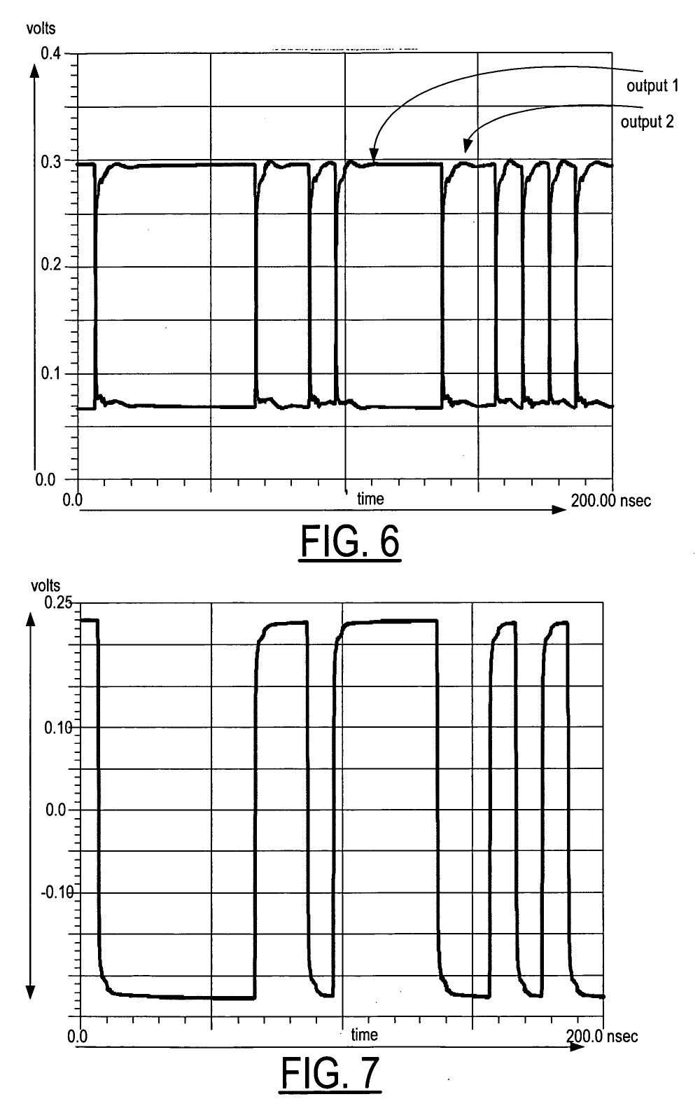

In accordance with some embodiments of the invention, a waveform representation of a differential signal as seen at the input of the receiver (Rx) when measured by single ended probes when the scalable low voltage signaling (SLVS) driver of FIG. 2 is used with a termination resistor at the receiver (Rx) input for high speed signaling is shown in FIG. 6. In this example, there is a 29 centimeter long very low quality interconnection between the driver structure and the receiver structure.

In accordance with some embodiments of the invention, a waveform representation of a differential signal as seen at the input of the receiver (Rx) when measured by a differential probe when the scalable low voltage signaling (SLVS) driver of FIG. 2 is used with a termination resistor at the receiver (Rx) input for high speed signaling is shown in FIG. 7. In this example, there is a 29 centimeter long very low quality interconnection between the driver structure and the receiver structure.

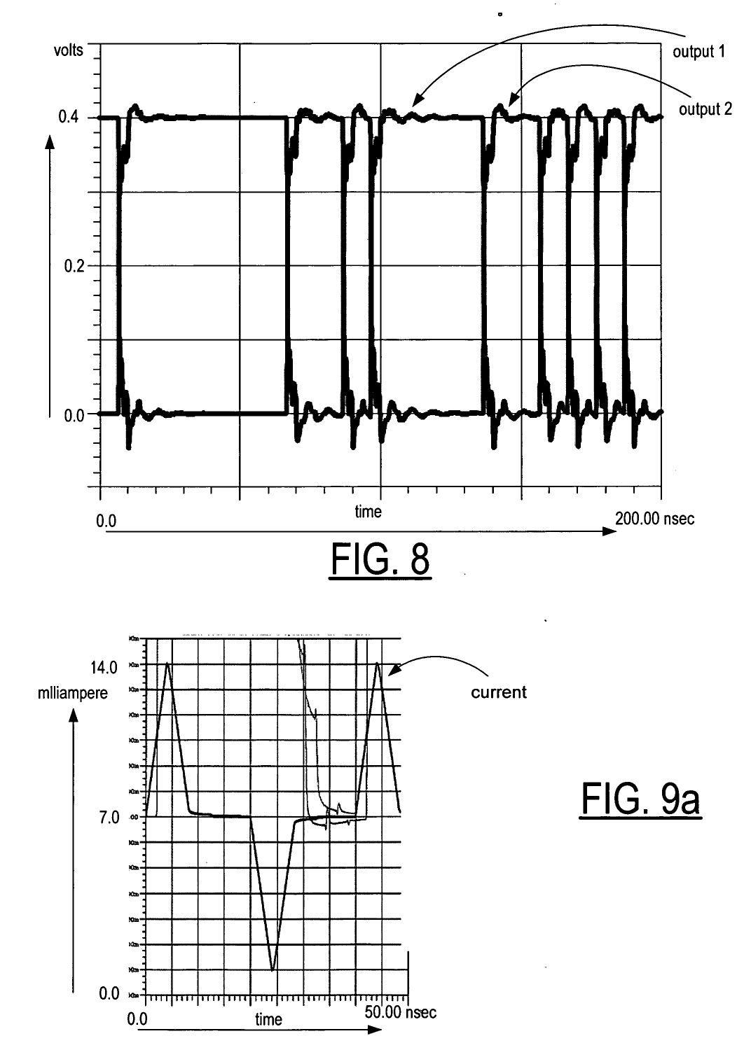

In accordance with some embodiments of the invention, a waveform representation of a single-ended signal as seen at the input of the receiver (Rx) when the scalable low voltage signaling (SLVS) driver shown in FIG. 2 is used without a termination resistor at the receiver (Rx) input for slow-speed signaling is shown in FIG. 8. In this example, there is a 29 centimeter long very low quality interconnection between the driver structure and the receiver structure.

In accordance with some embodiments of the invention, the single-ended signaling is also used for wake-up purposes by disconnecting the termination resistors at receiver. The signal amplitude of one single wire will then change nominally between 0 volt and 0.4 volt. The 0.4 volt single-ended signal is sufficiently large enough to be reliably detected by the CMOS inverter powered from a 0.4 volt supply voltage.

This 400 millivolt signal is not large enough that any additional voltage levels could be detected, making contention detector systems impossible or at least they would take static power. Embodiments of the present invention are usable only in unidirectional data links such as found in M-PHY but not found in D-PHY.

A further benefit is obtained by using a 0.4 volt at the receiving CMOS inverter 14b and 14c in that the receiving CMOS inverter filters all high frequency interference particularly if a chain of a few inverters such as shown by way of example in FIG. 3 and generally designated 22 are used. A system, for example a camera and display in a mobile device or mobile terminal, implemented with a module comprising a serial interface embodying the invention would tolerate the same 200 mVpp (millivolt peak-to-peak) induced RF noise below 450 MHz as specified for D-PHY.

Reducing the signal amplitude from 1.2 volts to 0.4 volt would reduce the required current for high speed operation from 12 milliamperes to 0.4 volt×(50+50) ohms=4 milliamperes. This amount of current is less than is required with a maximum allowed load of 70 pF (pico-farads) for 10 Mbps in D-PHY. For electromagnetic interference (EMI) considerations, the rise time also needs to be limited with 4 milliamperes, thus making the maximum bit rate in the range of 100 Mbps.

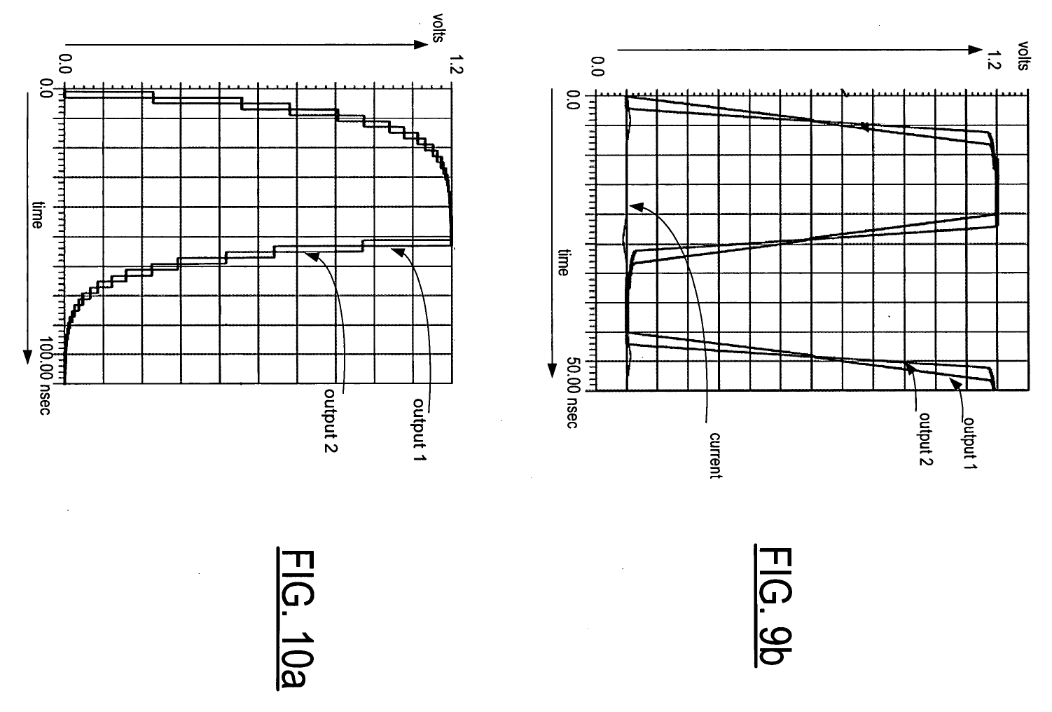

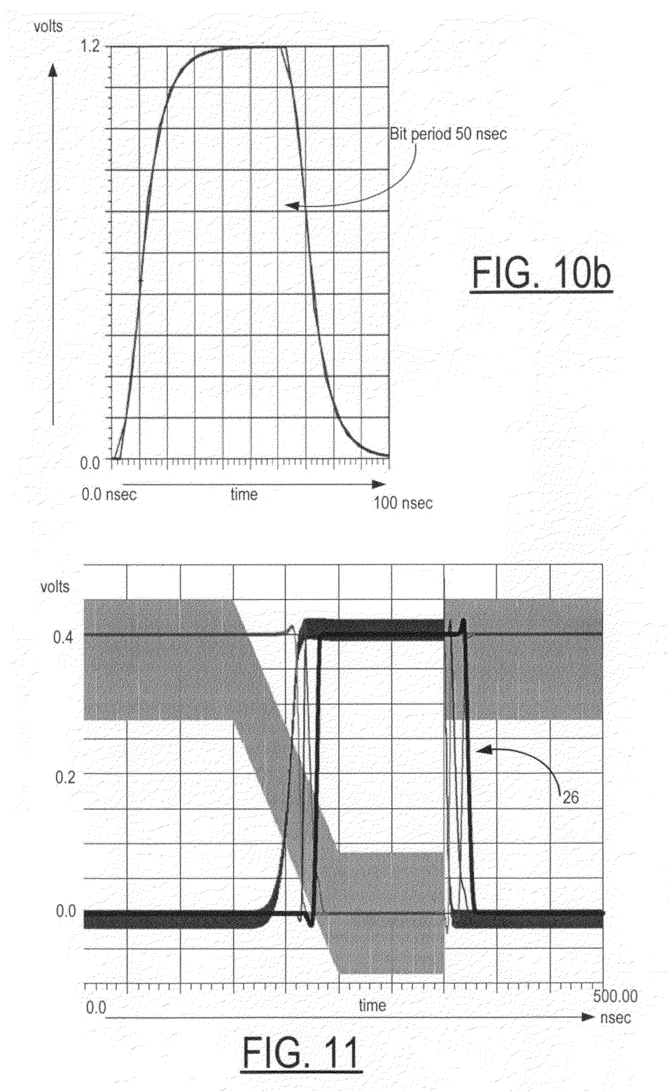

A waveform representation of the current and voltage signals respectively for a matched output impedance of 50 ohms for 1.2 volt signaling is shown in FIGS. 9a and 9b according to some embodiments of the invention. A waveform representation comparison of a 100 pico-second rise time and 10 nano-second rise time in 1.2 volt signaling is shown in FIGS. 10a and 10b according to some embodiments of the invention. The signal requires several back and forth propagation delays to reach final value if the output impedance is larger than the line impedance. If the rise time of the signal without a load is slow, the signal waveform will be smooth, but the time to reach the final voltage is the same and depends only on the output impedance.

The use of a 0.4 volt supply voltage would also make the receiver inverter used as comparator slow enough such that it filters radio frequency (RF) noise induced from transmitting antenna of the mobile device, and therefore the use of separate spike suppression circuitry is not needed as it is unnecessary.

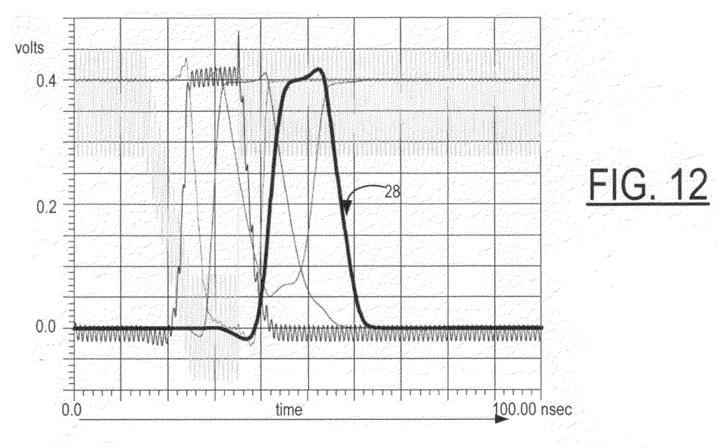

A waveform representation of filtering at the receiver (Rx) of 200 millivolt peak-to-peak 1 gigahertz noise in 400 millivolt 10 megabits per second single-ended signaling for some embodiments of the invention is shown in FIG. 11. A waveform representation of filtering at the receiver (Rx) 1 gigahertz 200 millivolt peak-to-peak noise in 400 millivolt 100 megabits per second single-ended signaling for some embodiments of the invention is shown in FIG. 12. The waveform 26 in FIG. 11 and the waveform 28 in FIG. 12 show the filtered signal at the output of a 5-stage inverter chaining with 3 times increased transistor size per stage.

In accordance with some embodiments of the invention, the biggest benefit of using 0.4 volts compared to 1.2 volts is the reduction of power consumption in single-ended transmission because the power supply voltage and signal amplitude are reduced from 1.2 volts to 0.4 volts. The reduction in power consumption using 0.4 volts signaling compared to 1.2 volt signaling is 89% (proportional to V²; 1−0.16/1.44=89%).

In addition, the maximum bit rate could in principle be very high and the length of the cable as long as needed, but because the output impedance tolerances of the drivers are not accurate enough, some reflections will occur from the drivers making the recommended maximum bit rate equal to a value where the bit period is less than the back and forth propagation delay of the cable.

A further benefit is there is no need to generate a relatively accurate 1.2 volt supply voltage for the 1.2 volt CMOS signaling used in D-PHY. It is expected that the 0.4 volt supply voltage will in any case be available in future mobile terminals when most interfaces will use the MIPI serial interfaces, however providing an accurate 1.2 volt supply voltage could be a problem.

It should be noted that a suitable signal processing device, such as a digital signal processor, a transmitting and a receiving device and memory and processors for carrying out the operational instructions and functions of the invention as contemplated herein are also considered to be part of the present disclosure. Such devices, processors, memory, and instructions sets are well known and understood by those skilled in the art and are not expressly set forth herein. The interactions between the major logical elements and functions should also be obvious to those skilled in the art for the level of detail needed to gain an understanding for implementing the present invention. It should be noted that some embodiments of the invention may be implemented with an appropriate signal processor such as shown in Figure, a digital signal processor or other suitable processor to carry out the intended function of the invention,

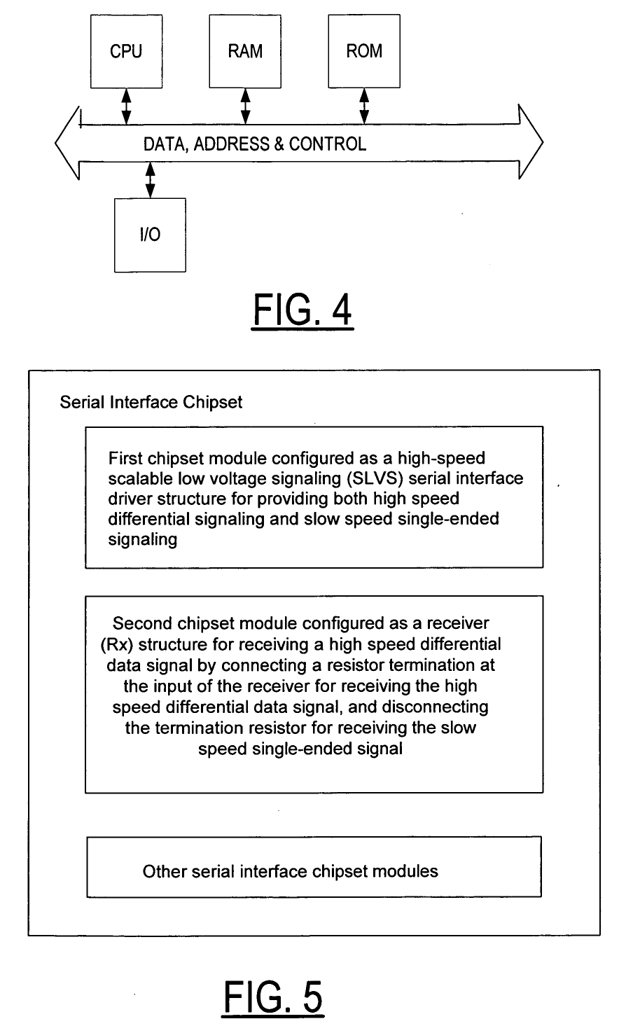

By way of example, and consistent with that described above, the functionality of the driver structures 10 and/or 14 may be implemented using hardware, software, firmware, or a combination thereof, although the scope of the invention is not intended to be limited to any particular embodiment thereof. In a typical software implementation, the driver structures would include one or more microprocessors-based architectures having a microprocessor, a random access memory (RAM), a read only memory (ROM), input/output devices and control, data and address buses connecting the same such as shown in FIG. 4. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the driver structures 10 and/or 14 being a stand alone module, as shown, or in the combination with other circuitry for implementing another module. Moreover, the real-time part may be implemented in hardware, while the non-real-time part may be done in software.

According to one example of the invention, the invention may be implemented as a chipset for example as shown in FIG. 5 with the serial interface driver structure 10 forming one chip of the chipset and the serial interface receiver structure 14 forming another chip of the chipset. Alternatively, both the driver structure 10 and receiver structure 14 may be implemented on a single chip.

According to a further example of the invention, the module comprising the serial interface driver structure 10 and the serial interface receiver structure 14 may be arranged and configured for implementation as an application specific integrated circuit.

It is to be understood that the above-described arrangements are only illustrative of the application of the principles of the present invention. Numerous modifications and alternative arrangements may be devised by those skilled in the art without departing from the scope of the present invention.

The invention claimed:

1. A module, comprising:
a serial interface driver structure configured for both high speed differential signaling and for slow speed single-ended signaling, and
a serial interface receiver structure arranged with a selectively connectable resistor termination at its input for receiving both the high speed differential signaling when the resistor termination is selectively connected to said receiver structure input, and for receiving the slow speed single-ended signaling when the resistor termination is selectively disconnected from said receiver structure input.

2. The module according to claim 1 wherein said driver structure is arranged as a scalable low voltage signaling driver structure.

3. The module according to claim 2 wherein said scalable low voltage driver structure is arranged as a totem-pole driver structure.

4. The module according to claim 3 wherein said totem-pole driver structure is an NMOS totem-pole driver structure.

5. The module according to claim 4 wherein said totem-pole driver structure is arranged as a 0.4 volt NMOS totem-pole driver structure.

6. The module according to claim 1 wherein said receiver structure is further arranged as an inverter comparator and configured for receiving said slow speed single-ended signaling.

7. The module according to claim 6 wherein said receiver structure is further arranged as a CMOS inverter comparator configured for receiving said slow speed single-ended signaling.

8. The module according to claim 7 wherein said receiver structure is further arranged as a 0.4 volt CMOS inverter comparator configured for receiving said slow speed single-ended signaling.

9. The module according to claim 1 wherein said receiver structure is arranged as a differential high-speed comparator configured for receiving said high-speed differential signaling.

10. The module according to claim 9 wherein said receiver structure is further arranged as a differential high-speed CMOS comparator configured for receiving said high-speed differential signaling.

11. The module according to claim 10 wherein said receiver structure is further arranged as a differential high-speed 0.4 volt CMOS comparator configured for receiving said high-speed differential signaling.

12. The module according to claim 1 wherein said selectively connectable resistor termination is arranged as a balanced load across the input of said receiver structure.

13. The module according to claim 12 wherein said driver structure is arranged with an output and has an output impedance, and wherein said receiver balanced load impedance is chosen to match the driver structure output impedance.

14. The module according to claim 13 the receiver balanced load impedance s a 50 ohm resistor termination.

15. The module according to claim 1 wherein the driver structure is further arranged such that the high speed differential signaling is configured for signaling in the range of 0-2 giga-bits per second, and the slow speed single-ended signaling is configured for signaling in the range of 0-100 mega-bits per second.

16. The module according to claim 5 wherein the amplitude of the high speed differential signaling signal is in the range of +200 millivolts to −200 millivolts, and the amplitude of the slow speed single-ended signaling signal is in the range of 400 millivolts.

17. The module according to claim 1 further arranged and configured for a unidirectional link between said driver structure and said receiver structure.

18. The module according to claim 1 further arranged and configured for use in a mobile device, mobile terminal or cellular telephone.

19. The module according to claim 1 further arranged and configured as a chipset.

20. The module according to claim 1 further arranged and configured as an application specific integrated circuit.

21. An apparatus, comprising:
a 0.4 volt NMOS totem-pole driver structure suitably arranged and configured for generating both a high-speed differential data signal and a slow-speed single-ended data signal on the same signal leads;
a CMOS invertor comparator operating from a 0.4 volt power source and suitably arranged and configured for receiving said slow-speed single-ended data carried by a respective one of said signal leads;
a differential high-speed CMOS comparator operating from a 0.4 volt power source and suitably arranged and configured for receiving said high-speed differential data signal carried by said signal leads;
a balanced load impedance matching the output impedance of said 0.4 volt NMOS totem-pole driver structure and suitably arranged and configured for suitable connection across the inputs of said differential high-speed comparator such that said balanced load impedance is connected across said differential high-speed comparator inputs for receiving said high-speed differential data signal carried by said signal leads, and said balanced load impedance is disconnected from said high-speed comparator inputs such that said CMOS invertor comparator receives said slow-speed single-ended data signal carried by said signal leads.

22. A device, comprising:
a module configured for communication interconnection between components in the device, said module including:
a serial interface driver structure configured for both high speed differential signaling and for slow speed single-ended signaling and a serial interface receiver structure arranged with a selectively connectable resistor termination at its input and configured for receiving both the high speed differential signaling when the resistor termination is selectively connected to said receiver structure input, and for receiving the slow speed single-ended signaling when the resistor termination is selectively disconnected from said receiver structure input.

23. The device according to claim 22 further configured as a mobile terminal.

24. The device according to claim 22 further configured as a cellular telephone.

25. A method, comprising:
generating both a high speed differential data signal and slow speed single-ended data signal from a single suitably arranged and configured scalable low voltage signaling (SLVS) high-speed low voltage serial interface driver structure, and
receiving at a suitably arranged and configured serial interface receiver structure the high speed differential data signal by connecting a resistor termination at the input of the receiver, and for receiving the slow speed single-ended data signal by disconnecting the resistor termination from the input of the receiver.

26. An apparatus, comprising:
one or more modules configured for generating both a high speed differential data signal and slow speed single-ended data signal from a single scalable low voltage signaling (SLVS) high-speed low voltage serial interface driver structure, and
one or more modules configured as a serial interface receiver structure for receiving the high speed differential data signal by connecting a resistor termination at the input of the receiver, and for receiving the slow speed single-ended data signal by disconnecting the resistor termination from the input of the receiver.

27. An apparatus, comprising:
means for generating both a high speed differential data signal and slow speed single-ended data signal from a single suitably arranged and configured scalable low voltage signaling (SLVS) high-speed low voltage serial interface driver structure, and
means for receiving at a suitably arranged and configured serial interface receiver structure the high speed differential data signal by connecting a resistor termination at the input of the receiver, and for receiving the slow speed single-ended data signal by disconnecting the resistor termination from the input of the receiver.
